(19) United States
(12) Patent Application Publication
(10) Pub. No.: US 2011/0197061 A1
(43) Pub. Date: Aug. 11, 2011

(54) CONFIGURABLE ONLINE PUBLIC KEY INFRASTRUCTURE (PKI) MANAGEMENT FRAMEWORK

(75) Inventors: Wei Lin Chou, San Diego, CA (US); Thomas J. Barbour, San Diego, CA (US); Liqiang Chen, San Diego, CA (US); Ying Chen, San Diego, CA (US); Christopher P. Gardner, La Jolla, CA (US); Jiajing Liu, San Diego, CA (US); Oscar Jiang, Rosemead, CA (US); Xin Qiu, San Diego, CA (US); Kyle W. Stewart, San Diego, CA (US); Chia Ling Tsai, San Diego, CA (US); Fan Wang, San Diego, CA (US); Ting Yao, San Diego, CA (US)

(73) Assignee: General Instrument Corporation, Horsham, PA (US)

(21) Appl. No.: 12/854,920

(22) Filed: Aug. 12, 2010

Related U.S. Application Data
(60) Provisional application No. 61/233,380, filed on Aug. 12, 2009.

(51) Int. Cl. H04L 29/06

(52) U.S. Cl. 713/156

(57) ABSTRACT

A method and apparatus is provided for establishing a process for provisioning a digital certificate service delivered by a PKI system. The method includes receiving a request for a digital certificate service and receiving data specifying a project that includes at least one product to be provisioned with a digital certificate. Data specifying an identification of an owner organization of the project and at least one participant organization participating in the project is also received. Attributes with which PKI data to be included in the digital certificates is to comply is received from the owner organization. Based on the received data and attributes, an account is established for each of the organizations associated with the project through which users associated with each of the organizations can respectively request digital certificates for the at least one product in accordance with the attributes received from the owner organization.

### STATEMENT OF RELATED APPLICATIONS

This application claims the benefit of U.S. Provisional Patent Application Ser. No. 61/233,380, filed Aug. 12, 2009, which is incorporated herein by reference in its entirety.

### BACKGROUND

Public key cryptography is an approach to enabling secure communications using key pairs. Each key pair includes a public key and a private key. The public key and private key are related so that, for example, a message encrypted by one key may be decrypted only by the other, but it is computationally infeasible to deduce the private key given the public key. In addition to message encryption, the key pair may be used to perform other functions as well. The private key is typically created and securely held by an entity; while the corresponding public key is typically made widely available. Secure communications between parties may then be enabled by using the parties' public and private keys.

The use of public key cryptography addresses many of the inherent security problems in an open network such as the Internet. However, two significant problems remain. First, parties must be able to access the public keys of other entities in an efficient manner. Second, since in many protocols entities are associated with and in some sense identified by their public keys, there must be a secure method for parties to verify that a certain public key is bound to a certain entity.

A public key infrastructure (PKI) system addresses these two problems. In one common approach, the public key infrastructure is based on digital certificates, which are used to associate a certain public key pair to a certain entity with some degree of integrity. The public key management infrastructure typically would include a database of digital certificates, certification authorities who issue the certificates, and other infrastructure for authenticating parties. A number of digital certificate services are typically provided in order to establish, disseminate, maintain, and service the public keys and associated digital certificates used in a PKI. These services are typically provided to end users by CAs or third party operators. The digital certificate services provided typically include the following: enrollment, status report, retrieval and search services as well as validation, revocation, renewal and replacement services.

The CAs in a PKI system perform a number of different functions. For instance, enrollment services provide users with information about their identities. A CA verifies the information and creates a valid digital certificate based on this information. Status report services allow users to determine whether a digital certificate is valid, revoked or has any other status. Retrieval services allow users to retrieve copies of digital certificates. Search services allow users to search for digital certificates which meet certain search criteria. Validation services allow users to establish the validity of a digital certificate, either currently or historically. Revocation services allow a user and a CA to act in concert to revoke a digital certificate. Renewal services allow a user and a CA to jointly create a new valid digital certificate, replacing a digital certificate that is about to expire. Replacement services allow a CA to create a new valid digital certificate, replacing a digital certificate which has been revoked.

In the era of information technology, PKI technology is being widely adopted by organizations to implement security features in the products and services they provide. A well implemented PKI system and its associated practices and procedures are often deeply involved in the organization's product development process, from the design phase all the way to the manufacturing phase. However, each organization typically has its own security policy, different manufacturing processes, and a unique style of engineering collaboration. All these differences have led to the development of complex and customized PKI systems that need to be maintained by each organization.

The scenario becomes even more complex when the security policy is defined and enforced by an external party, such as a consortium. As more and more standards or technologies are developed by multiple companies in collaboration with one another, consortiums are becoming a popular entity used to protect the best interests of all parties involved. Consequently, the integration between the consortium's PKI system and a participant organization's home-grown PKI system becomes an important but challenging task that every participant organization has to deal with. In some cases an organization is involved in multiple consortiums due to the diversified nature of many product development projects. For the consortiums, maintaining a sophisticated PKI system that supports the various security requirements imposed by the participating companies can be overwhelmingly difficult. Consequently, a well-integrated PKI platform that can be used by multiple consortiums and their participating companies, enabling them to offload significant amounts of overhead from both the consortiums and the participant organizations, allowing them to focus on product development.

### SUMMARY

In accordance with one aspect of the invention, a method is provided for establishing a process for provisioning a digital certificate service delivered by a PKI system. The method includes receiving a request for a digital certificate service and receiving data specifying a project that includes at least one product to be provisioned with a digital certificate. Data specifying an identification of an owner organization of the project and at least one participant organization participating in the project is also received. Attributes with which PKI data to be included in the digital certificates is to comply is received from the owner organization. Based on the received data and attributes, an account is established for each of the organizations associated with the project through which users associated with each of the organizations can respectively request digital certificates for the at least one product in accordance with the attributes received from the owner organization.

In accordance with another aspect of the invention, a system is provided to enable a plurality of organizations participating in at least one project to provision customized digital certificate services for the project. The system includes an account management component for establishing an account for each of the organizations associated with the project through which users associated with each of the organizations can respectively request digital certificates for at least one product included in the project. The system also includes a user management component configured to authenticate and authorize users associated with an owner organization of the project and at least one participant organization participating in the project who has been specified as a participant organization by the owner organization. The system also includes a certificate authority (CA) management component configured to generate at least one user-definable certificate profile template (CPT) that establishes a digital certificate format for digital certificates issued by all certificate authorities associated with the project. The system further includes a product management component configured to (i) establish attributes defined by the owner organization with which PKI data to be included in the digital certificates is to comply and (ii) establish a workflow of activities to be performed in order to generate the digital certificates with the attributes that have been established. The system additionally includes a PKI management component configured to process user requests for digital certificates from users associated with the owner organization or at least one of the participant organizations in conformance with the user management component, certificate authority management component and the product management component.

### BRIEF DESCRIPTION OF THE DRAWINGS

FIG. 1 shows the logical architecture of one implementation of a PKI management system.

FIG. 2 shows the pertinent components of the PKI system in FIG. 1 that are needed to illustrate at a high level the PKI data request process.

FIG. 3 shows a more detailed view of the logical architecture of the PKI service components 130 shown in FIG. 1.

FIG. 4 is an illustrative logical diagram of the relationship among projects, organizations, accounts, and users of a PKI system.

FIG. 5 shows a process for establishing a new project in the PKI Management System.

FIG. 6 shows a certification authority hierarchy with three levels.

FIG. 7 is a logical diagram illustrating how certificate authority keys and their associated certificates are linked to projects, organization-project accounts and products.

FIG. 8 shows the relationship between the root CA and the sub-CAs for the organizations X and Y shown in FIG. 7.

FIG. 9 shows one example of the relationship between a chain of CAs and the CPT associated with those CAs.

FIG. 10 shows an example of a report summary that may be presented to the user.

FIG. 11 shows a few examples illustrating how ID ranges can be allocated in the PKI management system.

FIG. 12 is a flowchart showing an example of a method by which an authorized user of an existing project can create product certificates for a product.

FIG. 13 shows a high level example of the process flow that may be used by the system to process PKI data.

FIG. 14 is a state diagram illustrating the order fulfillment process.

FIG. 15 is logical diagram of an organizational hierarchy that may be associated with a PKI system which illustrates various roles that may be assigned to users of the system.

### DETAILED DESCRIPTION

As detailed below, instead of organizing a PKI system that provides distinct services to different organizations, a PKI management system may provide distinct services to different consortiums and their participating organizations. An individual project may be, for example, the provision of one or more products that are to be loaded with identity data such as digital certificates and possibly other secure data. Multiple organizations may be involved in each project. In this way the problems concerning the PKI systems discussed above which arise when multiple organizations are involved in a common project can be ameliorated. As used herein an organization refers to any entity made up any number of individuals, regardless of legal structure or status. Nonexhaustive examples of such organizations include companies and corporations, both public and private, as well as non-profit and for-profit, government bodies or agencies and any other group of individuals and even groups of organizations.

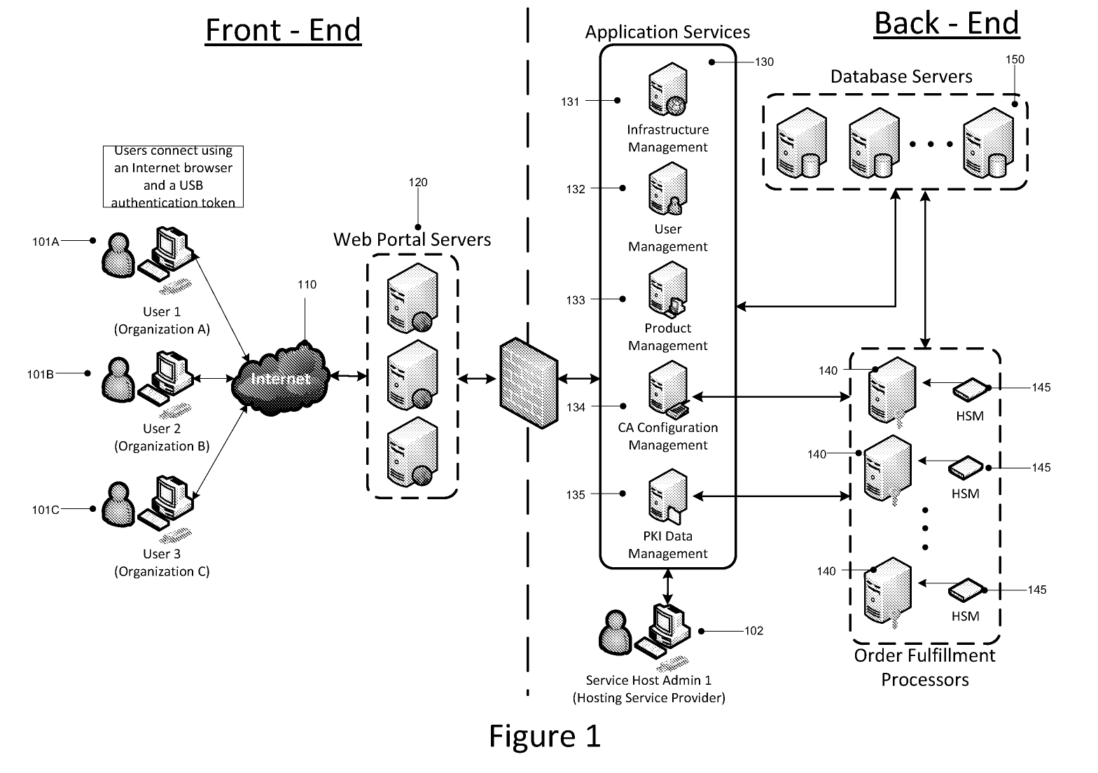

Turning now to the figures, FIG. 1 shows the logical architecture of one implementation of a PKI management system. The system includes multiple users 101A-101C (collectively, 101) who belong to one of three organizations A, B and C. The organizations may be companies and the users may be employees of the respective companies. The organizations A, B and C all employ the services of a PKI management system. The users 101 communicate with the system over the Internet 110 or any other packet-based wide area network. In this example the users access and interact with the system through one or more web portal servers 120, which provides a single front-end interface that is accessed by a client-based application such as a conventional web browser. Internal system administrative users who belong to the service provider's hosting organization can also access the system over the Internet or a local area network (LAN). Certain advanced administrative functions may be limited to LAN access only and may not be exposed to a public network.

The PKI management system typically includes one or more physical server computers with one or more physical storage devices and databases as well as various processing engines. In particular, in the example shown in FIG. 1 the PKI management system includes one or more service components 130 that typically reside on application servers which execute one or more applications that provide various PKI services to the clients 101. In FIG. 1 five logical service components or modules are shown: an infrastructure management component 131, a user management component 132, a product management component 133, a CA configuration management component 134 and a PKI data management component 135.

At a high level, the infrastructure management component enables the capability to maintain multiple public key infrastructures and related organizations in one unified system. The user management component defines the roles and grants accesses to users within the system. The product management component allows the participant organizations to implement and manage their own security policies depending on the PKI needs of various products. The CA configuration management component is used to manage various CAs and their policies as well as their associations with respective organizations and products. The PKI data management component not only provides conventional PKI data lifecycle management but also end-to-end request and delivery services.

Referring again to FIG. 1, the PKI management system also includes order fulfillment processors 140 which generate digital certificates or other identity data that a user requests for products. The order fulfillment processors may include, or have access to, hardware security modules (HSMs) 145 in which the CA's certificate signing private keys and secure data may be stored for use by the system.

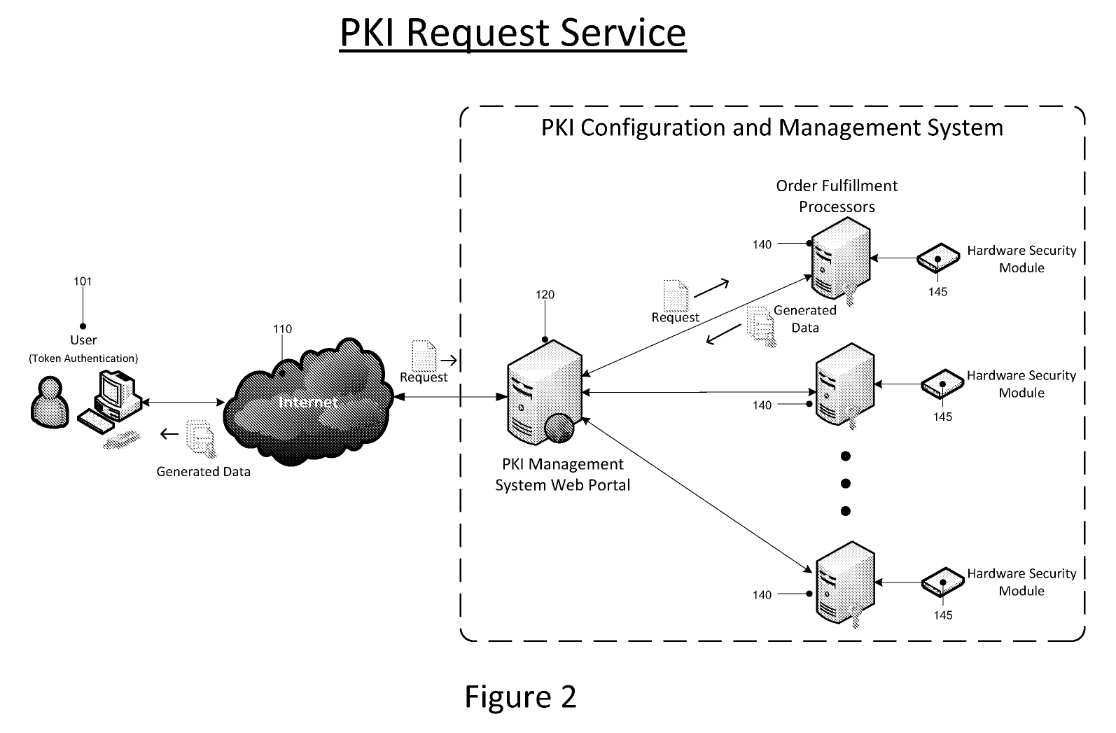

The PKI management system also contains a database 150 of records. These records may pertain to issued digital certificates, original requests for new digital certificates or secure data, audit data, control policy information, organization information, project configurations, account relationships, product configurations, user information, and other record types as necessary. FIG. 2 shows the pertinent components of FIG. 1 that are needed to illustrate at a high level the PKI data request process. First, as shown, the user is authenticated to ensure his or her identity. Next, the user, who may be a product administrator or authorized representative of a participating organization, submits a request over the Internet 110 to the web portal server 120, which in turn forwards it on the order fulfillment processors 140. The order fulfillment processors generate the requested data which can be subsequently downloaded by the user 101 via the web portal server 120 and the Internet 110.

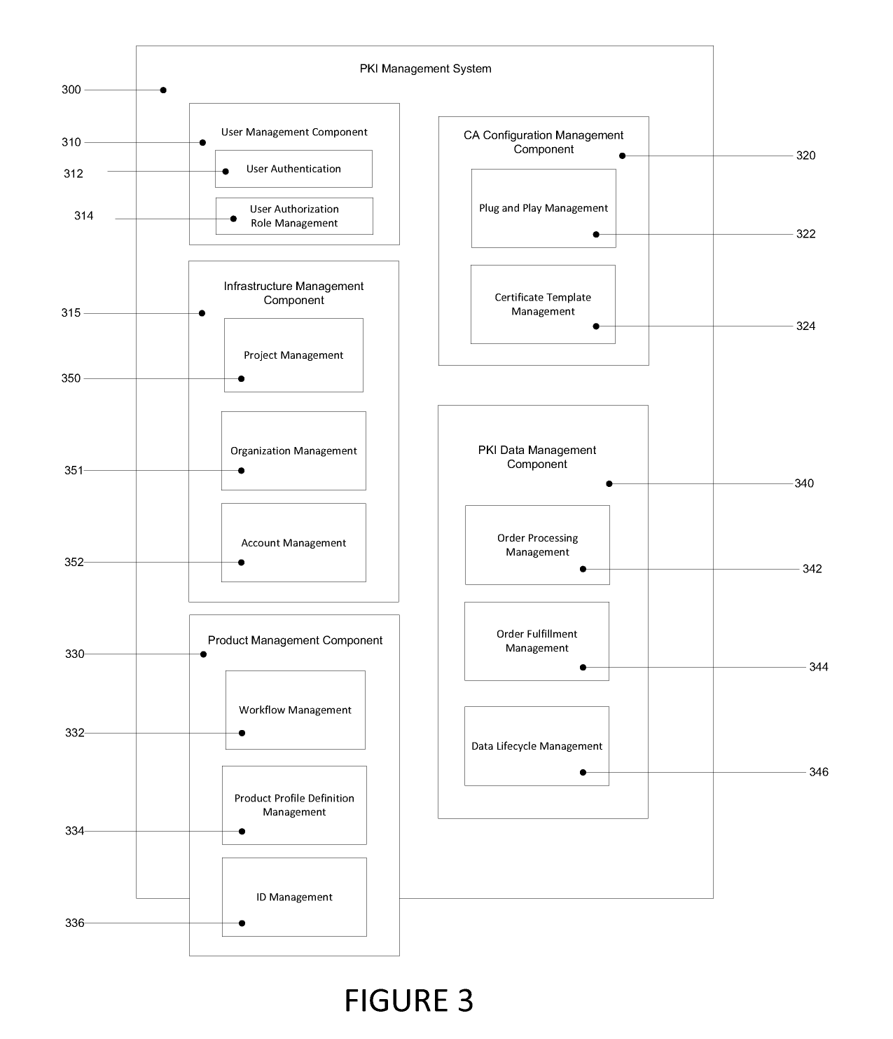

FIG. 3 shows a more detailed view of the logical architecture of the PKI service components 130 shown in FIG. 1 which addresses the management issues discussed above. As shown, these components of the PKI management system 300 include five management components. The infrastructure management component 315 consists of a project management sub component 350, an organization management sub component 351 and an account management sub component 352. The user management component 310 consists of a user authentication sub component 312 and a user authorization and role management sub component 314. The CA configuration management component 320 consists of a plug-and-play sub component 322 and a certificate template management sub component 324. The product management component 330 has a workflow management sub component 332, a product profile definition management sub component 334 and an ID management sub component 336. The PKI data management component 340 contains an order processing management sub component 342, an order fulfillment management sub component 344 and a data lifecycle management sub component 346. Collectively, these components allow for a completely dynamically reconfigurable PKI management system that can be fully customized without any system downtime or the need to perform any code changes whatsoever. For instance, new projects can be added, organizations/accounts within a project can be added or dropped, products can be added, and certificate chains within a project can be modified, all in an on-line environment that has been previously coded. Each of the aforementioned components and sub components are discussed in detail below.

### Infrastructure Management Component

When a new need for a PKI related system infrastructure arises, such as a new network requiring secure communications or a new type of device requiring specialized secure data, a new Project will be created within the PKI Management System. The project including PKI components, organizations, organization accounts, users, products, and manufactured devices, is also referred to as an “infrastructure” below.

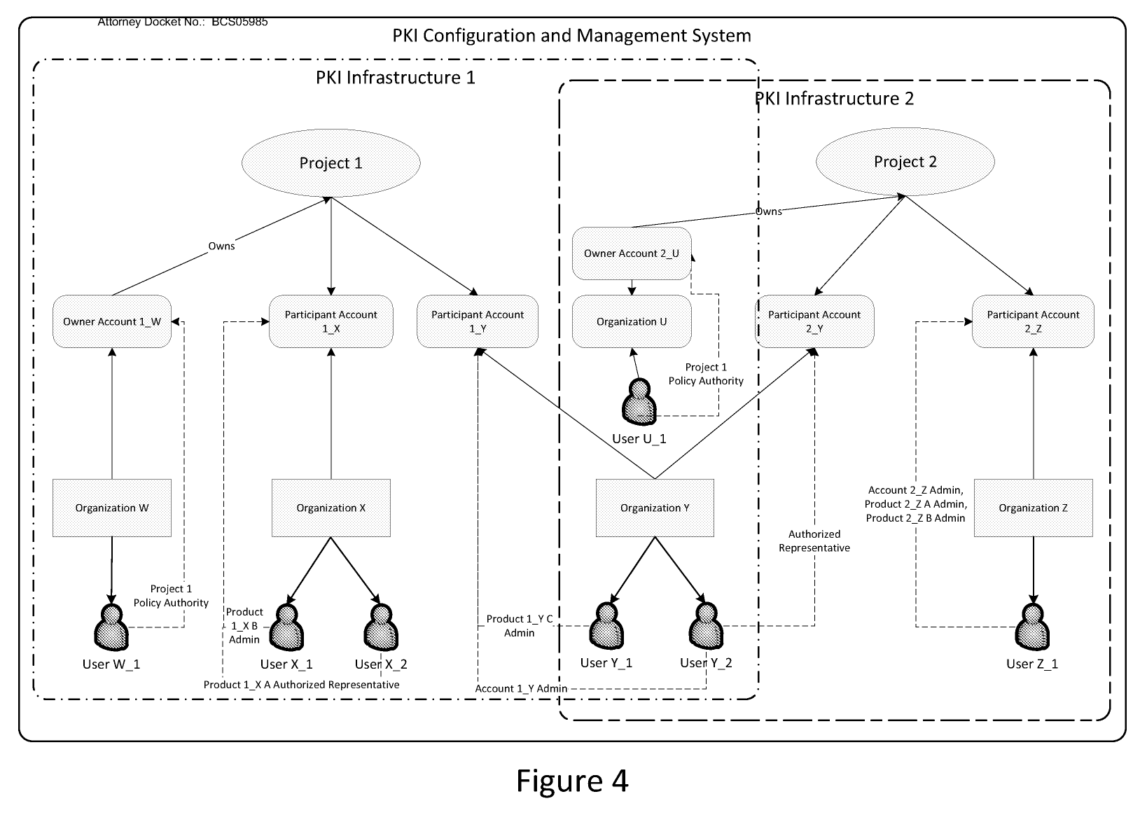

An illustrative logical diagram of the relationship among projects, organizations, accounts, and users is shown in FIG. 4. Two projects, projects 1 and 2 (or PKI Infrastructures 1 and 2), are involved in this example. Organizations W and X participate only in project 1. Organization U and Z participates only in project 2. Organization Y participates in both projects 1 and 2. As shown, each organization has one account for every project with which it is associated. Thus, while organizations U, W, X, and Z each has a single account, organization Y has two accounts. Each project is owned by one organization; for example, project 1 is owned by organization W and project 2 is owned by organization U. Moreover, one organization may participate in many projects. At the same time, many organizations may also participate in one project. Within each organization, users are authorized to perform different actions on different entities (e.g. organization, product, project, etc.) based on their roles and entity relationships. The roles may include but not limited to policy authority, authorized representative, product administrator, security officer, and account manager. For instance, as shown, User W_1 and User U1 are project administrators for projects 1 and 2 respectively. User X_1, User X_2, User Y_1, User Y_2 and User Z_1 are the organization administrators for their respective organizations. The user's role is inferred based on the type of account the organization has within the project. For example, User W_1 can be assigned a policy authority role for project 1 because organization W has the owner account for project 1. FIG. 4 also demonstrates that organizations, and their users, may cross domain to access different projects, which allows multiple public key infrastructures to be co-hosted under one PKI management system.

A concrete example will be used to facilitate an understanding of the PKI management system described herein. It should be emphasized that this illustrative example is presented by way of illustration only and not as a limitation on the methods, techniques and systems described herein. In this example project 1 involves the production of a series of different WiMAX™ products (e.g., models) that are to be loaded with digital certificates. An individual WiMAX device is one instance of a WiMAX product. The project owner, organization W, may be, for instance, the WiMAX Consortium responsible for establishing and managing the WiMAX standard. Organization W has an owner account under Project 1, as denoted as 1_W in FIG. 4. Organizations X and Y may be entities such as individual companies that produce WiMAX products which are a part of project 1 and these organizations wish to acquire digital certificates or other identity data that can be loaded into their respective devices. Both organization X and Y have participants accounts (1_X and 1_Y) under Project 1.

Similarly, project 2 involves the production of a series of different Long Term Evolution (LTE) products that are to be loaded with digital certificates or other identity data. LTE is a mobile communication standard that has been formally submitted as a candidate for 4G wireless systems. Once again, an individual LTE device is one instance of a LTE product. The project owner, organization U, may be the LTE consortium responsible for establishing and managing the LTE standard. Organization U has an owner account under Project 2, as denoted as 2_U in FIG. 4. Organizations Y and Z may be entities such as individual company that produces LTE products which are a part of project 2 and the organization wishes to acquire digital certificates or other identity data that can be loaded into the respective devices. Organization Y participates in the WiMAX project (Project 1) and also the LTE project (Project 2). It has two separate accounts 1_Y and 2_Y, which participate in projects 1 and 2, respectively.

Some general features and rules relating to the management of each project in this example will now be presented. First, regarding project management, it is assumed that each project can only be owned by one organization in the system, but that multiple organizations may participate in each project. Moreover, project policies can only be modified by the owner organization. Second, regarding management of the organizations, each organization can own multiple projects and multiple organizations can participate in multiple projects. It follows therefore that each organization can have multiple accounts within the PKI management system.

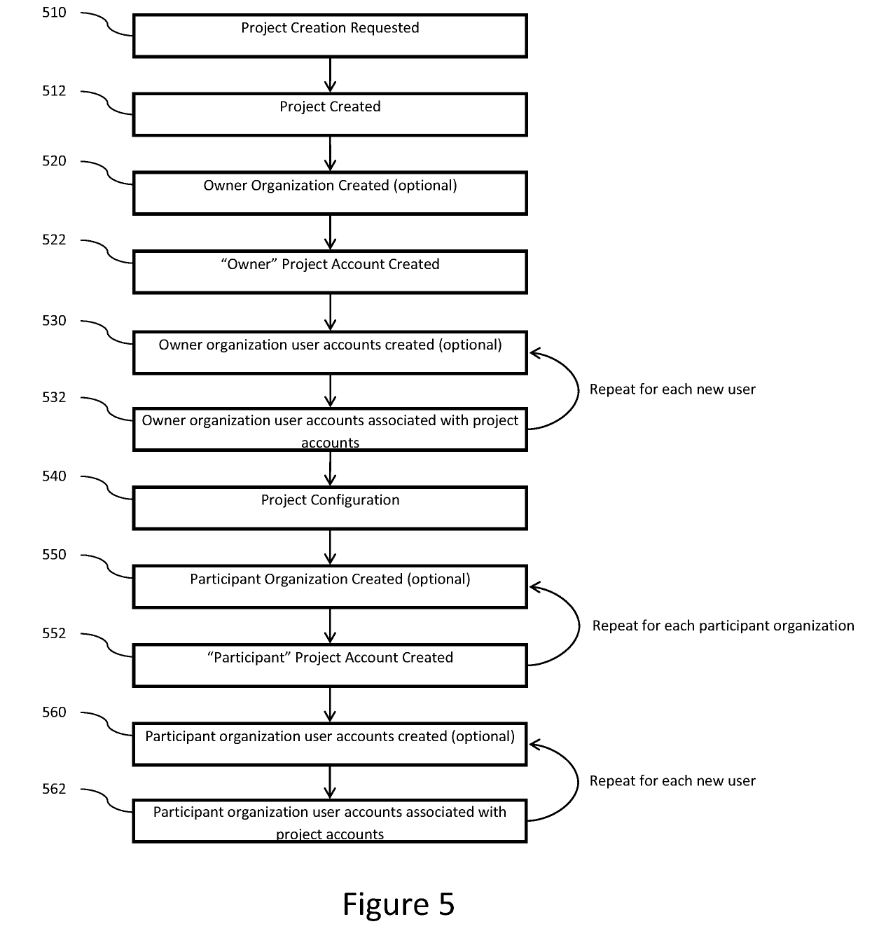

The process defined for introducing a new project to the PKI Management System is shown in FIG. 5. The project entity is created step 512 after a PKI management service provider receives a request in step 510 from an organization (e.g. a consortium) requiring a distinct public key infrastructure. The project is created using, for example, a web-based administrative portal which may be only accessible to the authorized host organization's users, such as a service host administrator. Through this interface the administrator enters any relevant project information to be stored in the database for further project configuration. The project creation and rules are handled by the project management sub component 350 as shown in FIG. 3.

Once the project is created, the owner organization is identified and created as needed (the organization may already exist in the system) as shown in step 520. A project-owner account is created to link the organization to its project. Note that only one organization may be designated as the owner of this project, but this logical organization may be managed by and composed of several other organizations similar to the typical consortium. In steps 530 and 532 the owner organization's user accounts may be created and associated with the project respectively. These steps can occur any time after the owner organization has been established. The owner account link between the organization and its project grants proper control over various configuration values and access to other information pertinent to its users.

After all the organization, project, and user accounts are properly setup, an authorized user, such as someone with the policy authority role for the project, configures the project in step 540. The project configuration includes specifying project attributes to be used throughout the infrastructure including but not limited to PKI data attributes, CA structure, and various other security and operation parameters.

Any time after a project is created, other organizations may request participant accounts. If an organization does not exist in the system, it can be created in the system by an authorized service provider user as in step 550. Once created, a project-participant account links the participating organization to the project in step 552. Then the proper user accounts can be created and associated with the project account as shown in steps 560 and 562. This enables the participant organization to create and configure products as described in the “Product Configuration Management” section.

The rules and relationships of organizations and their accounts are managed by the organization and account management sub components 351 and 352 respectively as shown in FIG. 3.

The user accounts and management will be discussed in detail below.

The above process can be repeated for each project requested. The flexibility of the system allows projects to be added and modified at runtime without interrupting the live system or altering its implementation.

### Certificate Authority (CA) Configuration Management Component

In FIG. 3, the certificate authority (CA) configuration management component 320 consists of two sub-components: the plug and play management (sub-component 322) and the certificate template management (sub-component 324).

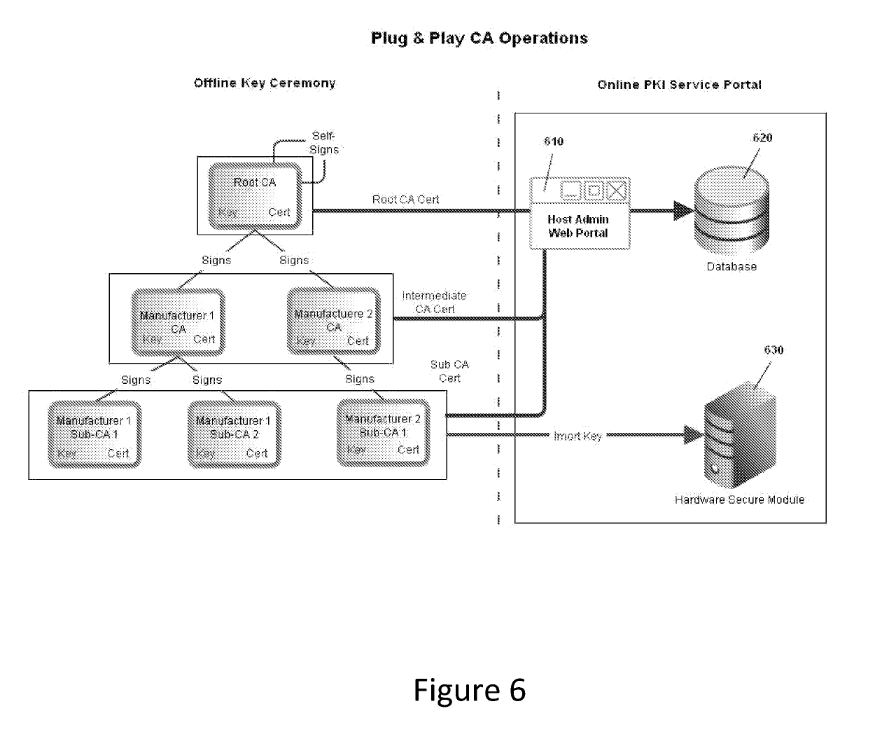

When generating CA certificates, keys and certificates are generated in a secure offline environment in a procedure known as a key ceremony. In FIG. 6, a three level CA-chain is shown as an example. The root CA certificate is self-signed. The intermediate level CAs are then certified by the root CA and the lowest level CAs are certified by the intermediate CAs.

After the key ceremony, only the lowest level CA key pairs are imported directly into the hardware security module 630. The entire CA certificate chain is imported into the PKI Management system's database 620

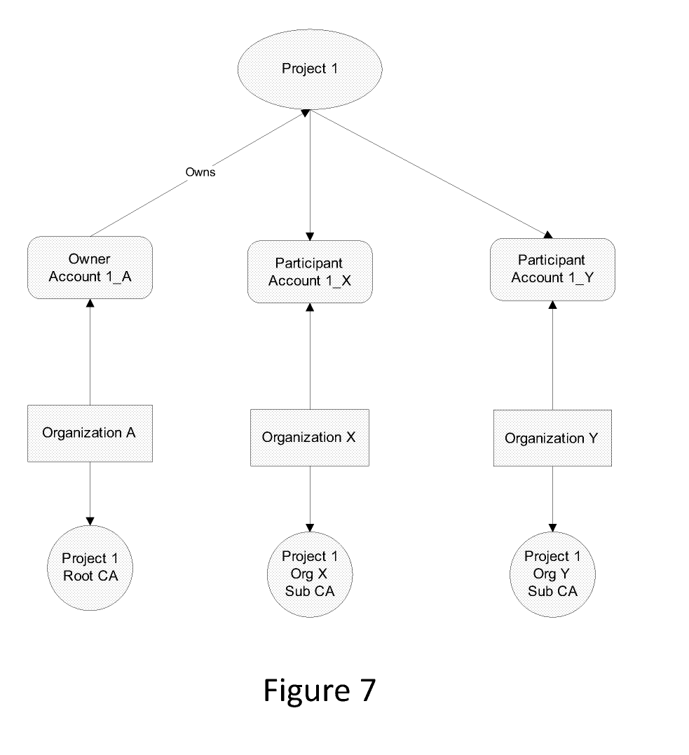

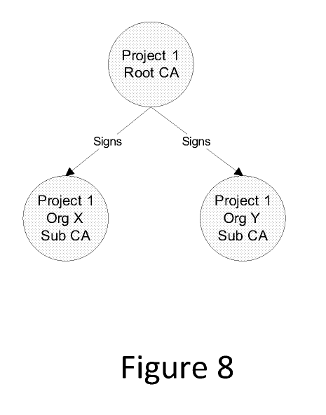

The plug and play management sub component (322) is used to link the CA keys and associated certificates to projects, organization-project accounts and products. As shown in FIG. 7, the root CA is associated with the owner organization Account 1_A. An owner organization may have one or more root CAs for different purposes. For example, a project may need a server root CA for server certificates and another root CA for device certificates. Likewise, the participant organizations can have as many sub-CAs as needed, each tailored to the PKI needs of a different product. However, the owner organization of a project may restrict the number of hierarchical levels of sub-CAs may exist below their root CA. The number of sub-CAs which exist for a participating organization at a hierarchical level may also be limited. The sub-CAs are associated with the corresponding participant organization accounts, such as accounts 1_X and 1_Y. FIG. 8 shows the relationship between the root CA and the sub-CAs for the organizations X and Y shown in FIG. 7. This plug and play operation is performed directly on a live system without any service interruption.

The certificate template management component 324 in FIG. 3 provides a configurable mechanism to ensure that the digital certificates remain consistent throughout the entire certificate chain and remain in compliance with the project owner's requirements. For instance, this component enforces policies or constraints established by a parent CA when a sub-CA generates child level certificates. A Certificate Profile Template (CPT) is included to define all the required and optional fields which are to be present in the descendant certificates. By design, each CPT is associated with one CA. Prior to generating a digital certificate, the certificate template management component 324 in FIG. 3 locates any relevant CPT by searching upward in the certificate chain. Any such CPTs located are used to enforce the policies imposed by the corresponding CA.

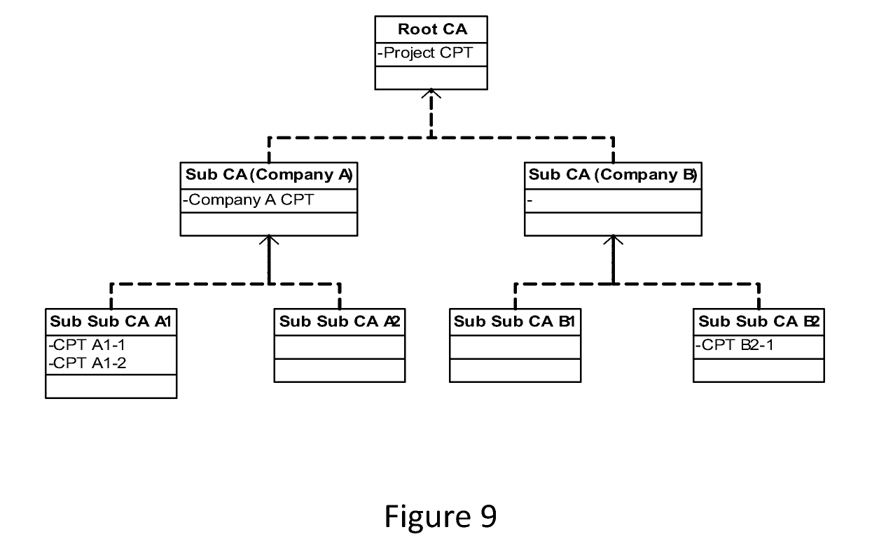

FIG. 9 shows one example of the relationship between a chain of CAs and the CPT associated with those CAs. In this example the root CA has a CPT for the entire project (the “project CPT”) with which all sub-CA must comply. The sub-CA for company A has more specific or refined requirements in its CPT (the “Company A CPT”), which are consistent with the CPT of the root CA. On the other hand, sub sub-CA for company B1 simply uses the CPT of the root CA.

### Product Management Component

Each manufacturer's product protected by the PKI management system has product specific attributes associated with it that are to be included in the digital certificate. These attributes may include, for instance, the data format, protection mechanism, Identification (ID) type, and actions that need to be performed to generate the data. All the PKI data generated for a particular product may have a common format. However, the user's access to the PKI management system when requesting PKI data for devices is restricted to the organization with a corresponding project account.

The product management component 330, as shown in FIG. 3, consists of 3 sub-components: a workflow management component 332, a profile definition management component 334, and an ID management component 336.

The profile definition management sub component 334 is used to define and manage a product's profile and attributes. Examples of product attributes include product name, product manufacturer name, model name, and the identity of the chipset used in the product. The profile information consists of details that further describe each product such as the profile type, the ID type used to uniquely identify the device entity (e.g. MAC Address), and the certificate authority chain with which it is associated as well as the certificate profile template (CPT) with which it is associated. The profile type indicates what secure data output that the profile produces. The output may be a combination of certificate and corresponding key pair or just a certificate generated based on the certificate signing request. In the latter case (a certificate only profile), the key pair is generated separately by the participating organization and its public key is submitted to the PKI management system for certificate generation. This case requires the participating organization to have key pair generation capabilities.

The ID management sub component 336 controls the type of ID along with the allocated ranges that a product uses. Illustrative examples of ID types include a MAC address, serial number, Fully Qualified Domain Name (FQDN), IP address, and an International Mobile Equipment Identity (IMEI) number. An owner organization can also define its own ID types for its project. Among other things, the ID management component 336 specifies whether an ID can be reused for a product. For example, an ID could be reused by another product or by the same product when a certificate is to be renewed. If ID reuse is not allowed, the component will prevent the requesting user from generating data with a duplicate ID.

The ID management sub component 336 also ensures that only valid IDs are used for each product in accordance with rules established by the owner organization and/or the participant organizations. For ID types that follow a standard format, this component ensures that only IDs within the appropriate and pre-allocated range are used. For example, if the ID type is a MAC address, the ID management sub component 336 verifies that the Organizationally Unique Identifier (OUI) is used for intended the organization. The ID management sub component 336 allows the user, who may be a product admin for a participating organization, to assign different address ranges for products. It also allows product admin to specify how an individual ID or a range of IDs are used for certificate generation for their products. For an example, a specific value of ID can be entered by a user when requesting the PKI data for a device, or a “next available” address option which automatically calculates the first continuous unused allocation of IDs can be selected for certificate generation of the device. In some cases a product may need to be assigned some special patterns when selecting its ID ranges. For instance, a product may use only even MAC addresses within a specific range of addresses while reserving every odd MAC address for a different interface. This is referred to as address skipping. Based on a product's definition, an organization may or may not use the addresses that have been skipped in another product.

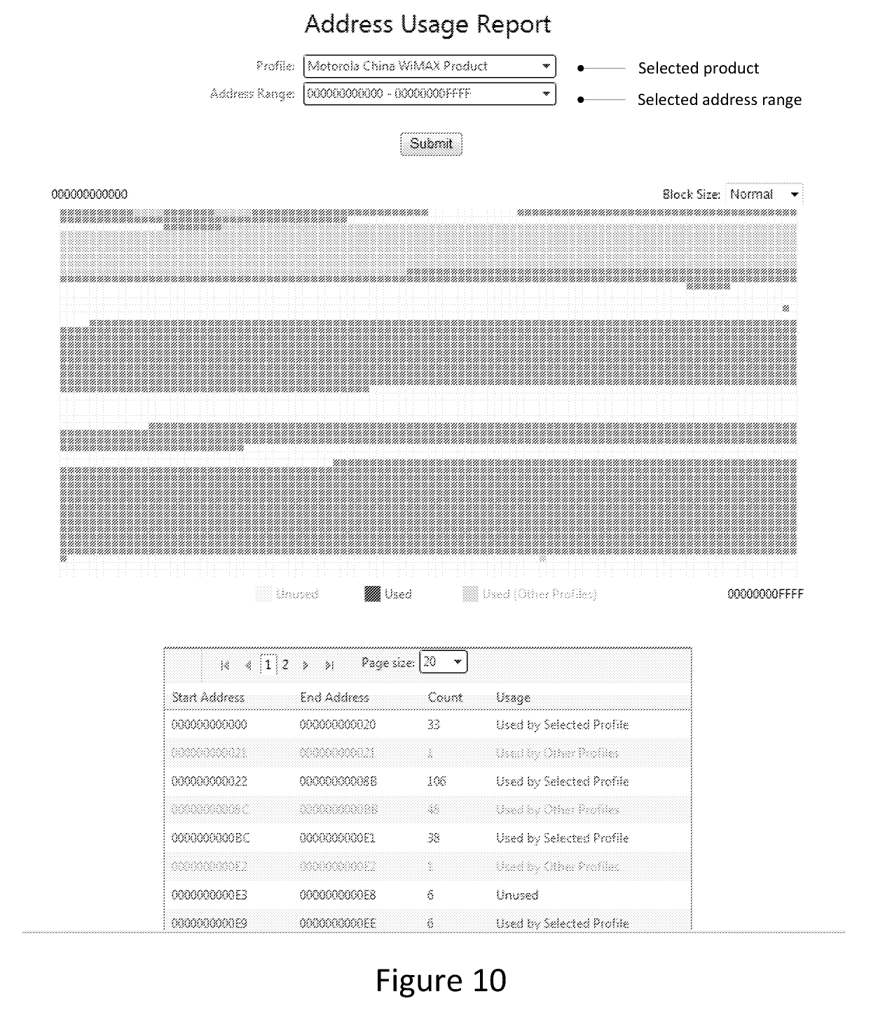

The ID management sub component 336 may also track the usage of the ID resources and provide users, who may be account administrators, product administrators, or authorized representatives of an organization with a participatory account, with informative ID usage reports. The ID usage can be tracked and reported across products and project accounts. This enables the users to monitor the overall usage of ID ranges pre-allocated to authorized accounts, as well as the usage details for each individual product. The ID usage reports may be generated through a user interface in real time as illustrated in FIG. 10, or may be delivered offline to these users depending on specific business requirements. The figure shows an example of the ID usage report for a specific product. In this example, authorized users are able to monitor the MAC address ranges that were used by the selected product and in selected address ranges which were pre-allocated to the specific product. MAC addresses used in the same address range by other products may also be shown in the same diagram with different colors. This service allows participating organizations track and manage their identity usage.

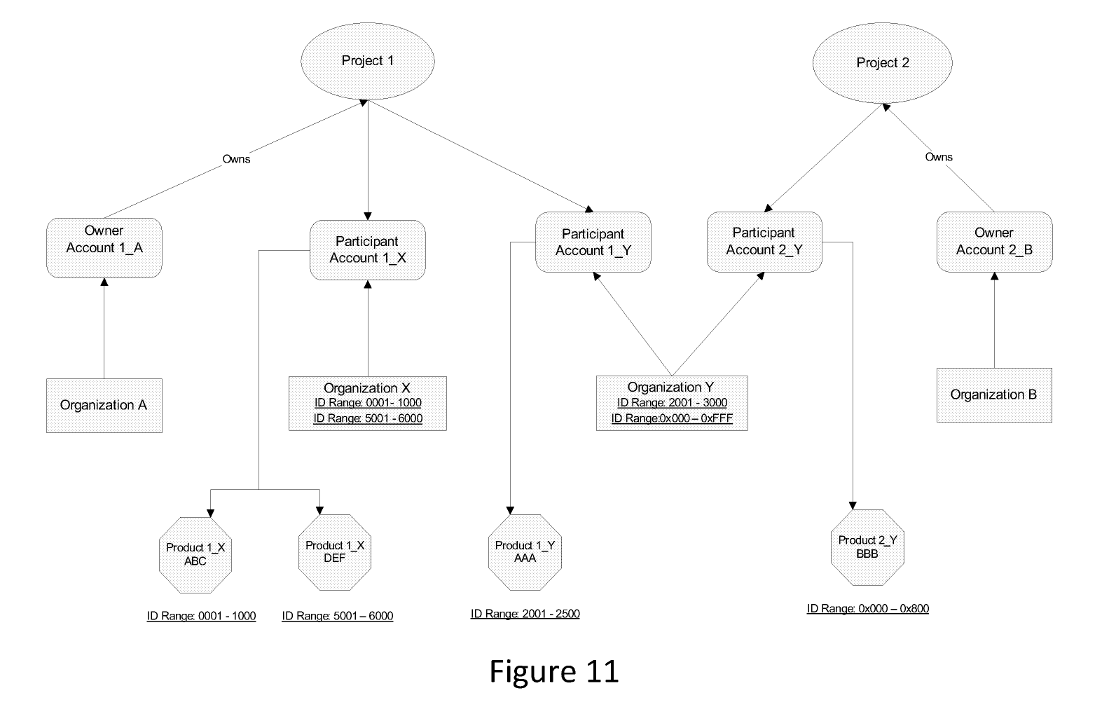

FIG. 11 shows a few examples illustrating how ID ranges can be allocated in the PKI management system. For instance, both product 1_X ABC and product 1_X DEF are under Organization X's account 1_X for Project 1. They share the same ID type. However, Product 1_X ABC uses the range 0001-1000, while product 1_X DEF uses the range 5000-6000. In addition, Organization Y participates in two projects: Project 1 and Project 2. Product 1_Y AAA under its Account 1_Y for Project 1 uses ID type 1 within the range 2001-2500 while Product 2_Y BBB under account 2_Y for Project 2 uses ID type 2 within the range 0x000-0x800.

Referring again to FIG. 3, the product management component 330 also includes a workflow management component 332. A workflow defines the sequence of actions that the infrastructure performs to generate and validate the necessary PKI data for a specific product. These actions are referred to as activities. For example, “generate RSA key pair” can be one activity, “verify certificate” can be another activity. Activities are the smallest reusable units. They can be shared by multiple workflows. Workflows can also be shared among several products or even across multiple projects. However, each product can only have one workflow. The workflow management sub component 332 defines and manages the relation between products and workflows. When an order is placed for a certain product, the product's workflow is executed.

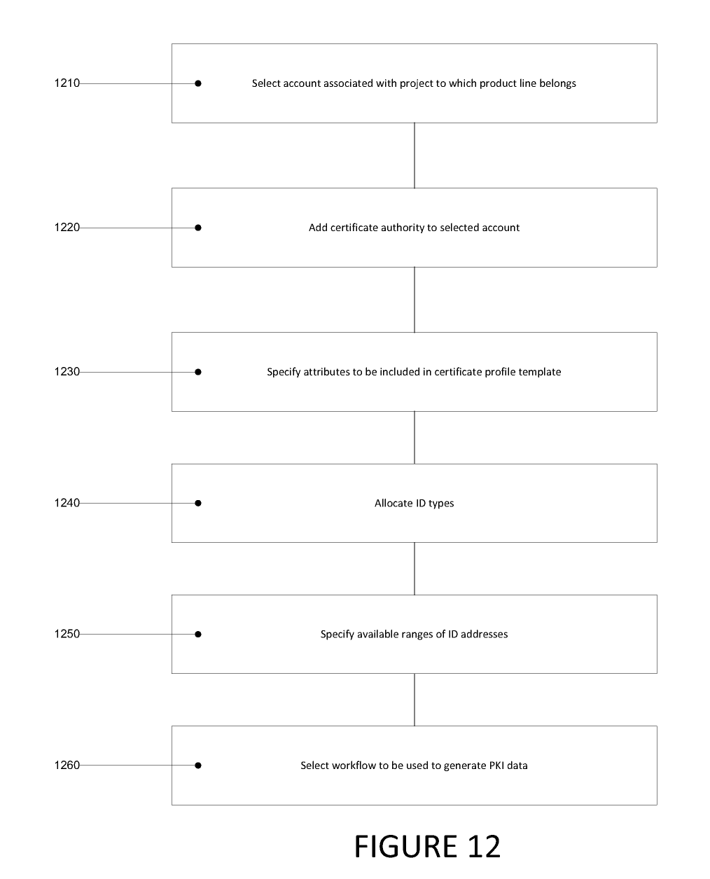

Once an organization is registered for an existing project, an authorized user, which may include a hosting organization user or a product administrator from a participating organization, can create product certificates for a product using the following procedure, which is illustrated in the flowchart of FIG. 12. First, in step 1210 the user selects the account associated with the project to which the product belongs. Next, in step 1220, the user adds to the account the CA(s) which is to be associated with this product (multiple sub-CAs are allowed for the same product as long as they are under the same certificate chain). A CPT is selected in step 1230 from among the list of available CPT that have been previously established for that organization and the user specifies various certificate profile attributes, which results in a Product Certificate Profile (PCP). ID types are allocated by the user in step 1240. In step 1250 the available range of ID addresses are specified along with any specific rules that are to be followed when allocating IDs within the available range (such as address skipping). Finally, in step 1260 the user selects a workflow which generates the PKI data in the appropriate format, uses the desired protection method, and so on. By allowing participating organizations to configure their products from the online system environment, organizations are able to create new products as needed, without having to wait for or rely on the hosting organization's staff.

### PKI Data Management Component

The PKI data management component 340 processes user requests (“orders”) for generating PKI data and maintaining that data throughout its lifetime. This component may be logically divided into three sub-components. An order processing management sub component 342 prioritizes and categorizes the orders. As authorized users (such as product administrators or authorized representatives) submit orders, several attributes of the orders are examined in order to determine the sequence in which they are to be fulfilled. An order fulfillment management sub component 344 executes the orders in accordance with the order specified by the order processing management sub component 342. Finally, a data lifecycle management component 346 maintains the PKI data that has been generated throughout its lifetime.

A number of benefits arise from providing the services delivered by these sub components in a common platform. First, by centralizing the processing in one system their processing can be optimized because load balancing can be used along with parallel processing, which is generally more efficient than trying to streamline several systems that each process orders serially. In addition, the data lifecycle is simplified for users by allowing them to manage and monitor the PM data in one place instead of using several disparate, dedicated systems. The PKI data can also be better secured since it is controlled by a single system which has control throughout the entire workflow, and thus there is no need to rely on an external party to secure the data. Each of the individual sub-components will now be described in more detail.

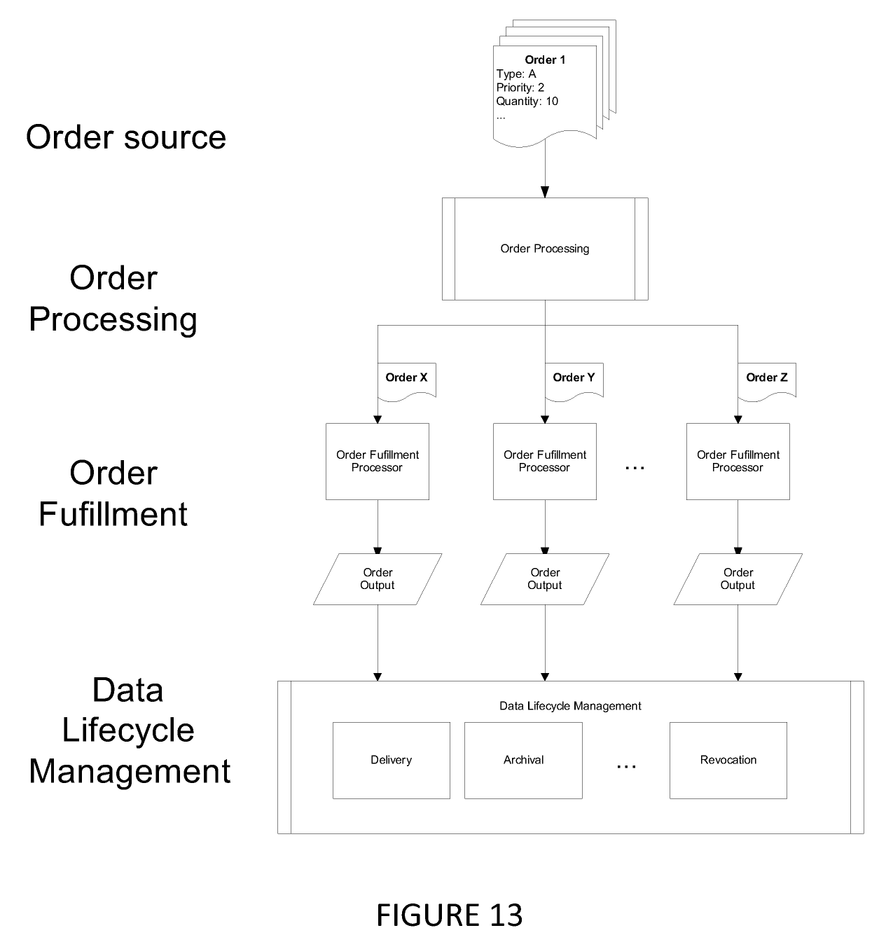

The order processing management component 342 can receive and process many orders and determine when they need to be processed. Two primary considerations are involved in this process: order prioritization and load balancing. FIG. 13 shows a high level example of the process flow that may be used by the system to process PKI data.

The order processing management component 342 in FIG. 3 can take into account many factors which characterize an order when selecting the next order that is to be processed. By way of illustration, these factors include priority, quantity, request type, data type and age.

A priority value can be assigned either by the requesting user or by the system itself. If it is specified by the user, some limitations may be put in place to prevent user abuse and ensure that the system can continue to process other orders. These limitations may imposed by requiring higher fees for prioritized services. In some cases authorized users, such as service host administrators, may manually adjust the priority for exceptional situations, or the system may be configured to automatically adjust the priority of certain orders under predefined circumstances.

Depending on the system's current load, some orders that require a small quantity of digital certificates can sometimes be expedited so that they are not blocked by larger orders. Also the total number of larger orders processed by the system may be kept below some threshold so that an order fulfillment processor can always be available for higher priority orders. This threshold does not limit the number of orders remaining in the queue. Order processing may also take into account the type of request included in the order. Different request types (i.e., the format of the order) generally require different amounts of processing, which in turn determines how much time it will need to be completed. Each order will also have a data type determined by the size of the PKI output data, the generation algorithm used, and other factors that will determine how long it will actually take to generate the data in the order relative to the data in other orders. For example, data that contains a 2048 bit RSA key will take longer to generate than data that contains a 1024 bit RSA key, and this information can assist in predicting the time it will take to fulfill an order.

The amount of time that an order has been waiting to be processed may also be monitored. Older orders may be given some level of priority over more recent orders so that no orders are delayed for an unreasonable amount of time.

In summary, the calculated priority C of an order can be expressed by the following equation:

C=wₚ*P+w_{c}*Q+wᵣ*R+w_{d}*D+wₐ*A

In this equation each summand is calculated using the product of a configurable weight for each parameter (where wₓ is the weight for parameter X) and a numeric value assigned to the parameter itself. Each parameter (P, Q, R, D, A) respectively represent the priority, quantity, request type, data type and age factors discussed above. This equation allows a real time adaptive order prioritization to be determined in a quantitative manner based on all the given parameters.

The order processing management component 342 can also take into consideration load balancing. That is, in addition to selecting the sequence in which to process orders, load balancing may also be applied. Orders can be mapped to the available processing units (e.g., order fulfillment servers). Each fulfillment server can handle multiple threads of the order fulfillment processes. As the system grows, more and more order fulfillment servers may be added, each having multiple processing cores available. A variety of load balancing techniques may be used to handle incoming orders. For instance, in some cases there may be two modes of operation. In mode I each order is assigned to a single thread on an order fulfillment server. This mode of operation optimizes the system when handling a large number of orders in parallel. In mode II one order is distributed in parallel among several order fulfillment threads. This mode of operation optimizes the system when handling orders that are large in size.

In summary, the order processing management component 342 can sequence orders based on various factors and those order can be fulfilled in a parallel fashion using load balancing. Such an approach to order processing enhances the system flexibility while being scalable so that different projects with various types and amounts of orders can be readily served. This load balancing scheme is referred to as “Order Attribute and System State Driven Load Balancing” since the order types along with the system state are used to determine the load balancing method.

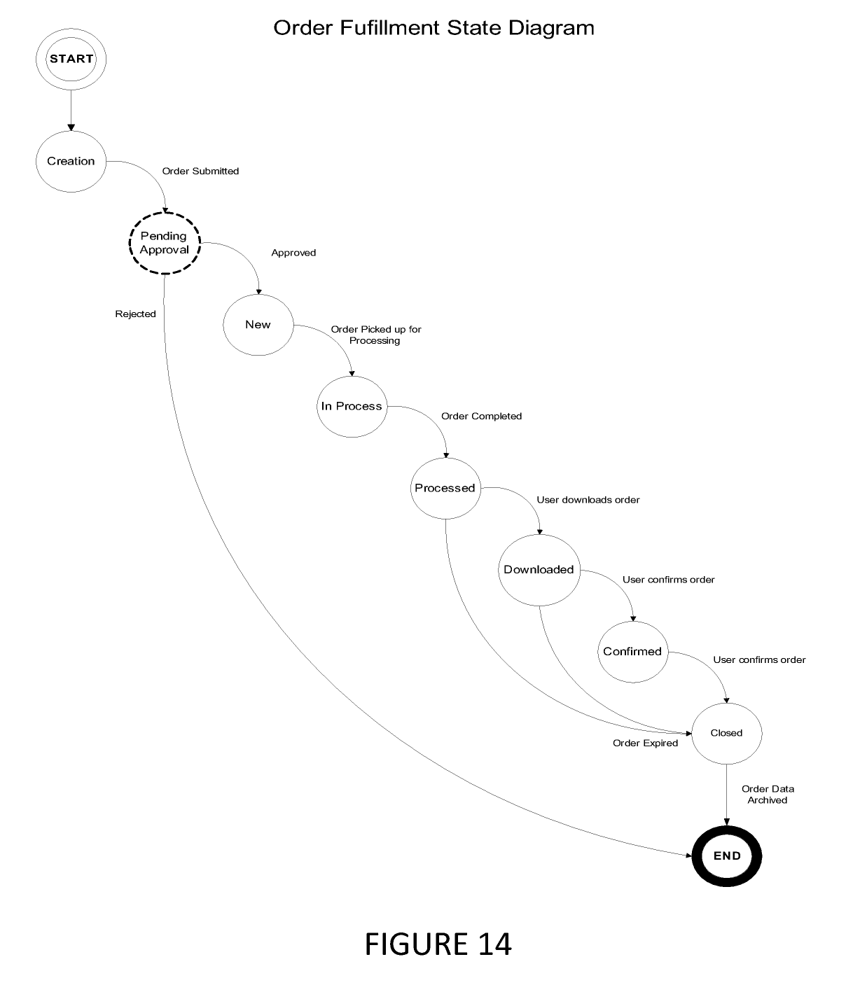

Once an order has been selected for processing, it goes through several stages during its creation, generation and management. This process is controlled by the order fulfillment management sub component 344. This process is described in connection with FIG. 14, which is a state diagram illustrating the order fulfillment process. The requesting user may place the order via a user interface that may be, for example, a web-based portal which dynamically generates its associated graphical user interface based on the data it receives from the user.

The process begins when a user creates an order request. When the component is in this creation state the user can select the type of request (e.g., certificate revocation, renewal, or generation) and, if applicable, which product is to be associated with the order. The user interface may first prompt the user to specify the particular product and request type (possibly from pull-down menus). The user interface may then present the user with additional prompts to specify other types of input data appropriate for this type of order. The other input data that is required may include, for example, a series of product attributes, an address range or a prompt requesting a certain data file. After the data is entered by the user the inputs are validated as being appropriate for the type of order being placed. Throughout the existence of an organization account for a project, payments are made to the financial entities associated with the host organization which are then converted using a pre-agreed rate to a balance representing the available amount of certificates the organization can generate. This balance may be allocated, for example, to the corresponding project account or to a specific product. An account's balance can be updated by an authorized user, such as a service host administrator. An account's balance can then be deducted during order submission to assure that the quantity requested is no more than the available balance for the given account and product selection. Furthermore, the balance may also be verified before each certificate is generated.

The next stage in the process is a pending approval state during which the order is either approved or rejected, assuming that such approval is required. Orders that do not require approval are automatically approved by the system, essentially making this stage optional. Once the order has been approved it enters a new state during which the order is queued up for processing. Once an order has been selected for processing it enters an in-process state during which the order is fulfilled by an order fulfillment server. Depending on the type of order (e.g., a certificate signing request or a certificate revocation request), a different processing module may be employed

After being processed the order has been completed and it enters the processed state. In some cases it is possible that some of the output records were not successfully processed due to invalid user input or some other problem. If an error occurs the system perform a ‘best-effort’ attempt to generate all the output records it possibly can and the order output is accompanied by a log indicating those records which were successfully processed and those that were not.

Next, in the downloaded state the output records in the order are configured into an appropriate format so that they can be downloaded by the requesting user, typically in an encrypted file (this protection mechanism is described in greater detail below). After the records are downloaded the order enters the downloaded state during which the user verifies that the data in the output records are accurate. This may be accomplished, for instance, using an ancillary application or program that has been provided to the user.

Finally, the order enters the closed state. This state may be reached by either the system automatically closing the order or the requesting user confirming the order has been fulfilled. The system may automatically close the order for any of a number of reasons. For instance, the order may be automatically closed after a configurable period of time has passed since the order has been processed. Alternatively, if the user confirms the order, it enters the confirmed state and closes immediately. In this way the owner organization can control the lifetime within the system of the system-generated data. In addition, by automatically closing the order, users are encouraged to actively monitor their data and confirm its validity before the order is closed. In some cases the owner organization may specify that the order is to be closed immediately after the output records have been downloaded, after the order is confirmed, or after some other period of time. Once an order is closed it may be archived and any private data associated with the order may be permanently deleted for security purposes.

Every order that is placed goes through each of the states described above, thereby allowing a single processing platform to be used. However, although a common process may be employed, each order may still be processed in a customized way depending on the order type, thus allowing for flexibility and extensibility. In addition, the use of a common set of processing states allows the system to more easily determine the status of any order at any given time, regardless of order type.

If a request generates sensitive data, such as private keys, that data may be protected (e.g. encrypted) for its delivery according to a protection policy defined by the project, participating organization, or the product. This protection may be enacted so that the data is only accessible to the user who requested it. This may be accomplished using a process related to the method by which the user is authenticated to the PKI management system. For example, if a user authenticates with the PKI Management system using a USB token which protects a private/public key pair and a certificate signed by an authorized CA (as discussed below in the User Management Component section), then the generated sensitive data may be encrypted with the user token's public key. Once delivered to the user, the data can be retrieved by decrypting the sensitive data with the private key secured on the user's token. This way the sensitive data that is generated by a request is linked to and only accessible by the requesting user.

The PKI data management component 340 in FIG. 3 also includes a data lifecycle management sub-component 346 for maintaining, managing and monitoring the PKI data that is generated. This includes the manner in which the PKI data is delivered to the user, the manner in which it is archived, including the archive duration and the time and conditions under which the certificates in which the PKI data is incorporated are revoked.

In order to simplify and secure data generation and maintenance, all aspects of the PKI data lifecycle can be managed within the PKI management system. The PKI data lifecycle is related to the types of requests users can submit. These requests include key and certificate generation, certificate signing request, renewal, certificate revocation and data archival and deletion.

A key and certificate generation request will cause the generation of keys and certificates for a given product with a desired set of input values and IDs within a specified range. A certificate signing request causes the generation of a set of certificates based on an input file containing multiple requests. A renewal request will cause the generation of new PKI data to replace data that has expired. Depending upon the request, this may or may not involve a ‘re-keying’ of the data. A certificate revocation order (i.e., a batch request) is placed if its corresponding private key is compromised. The revocation request causes the corresponding certificate revocation list (CRL) to be updated. A data archival and deletion policy determines how PKI should (or should not) be maintained as it ages. This policy may mandate some of it to be archived for later reference while some sensitive data is forcefully deleted from the online system as an extra security measure once it has been delivered to the user. In some cases keys that are being maintained in the system may be protected by allowing them to be released only by the user who requested them. The states of the order lifecycle are driven by the business requirements and security policies, which may include order approval, key deletion, and data archival. These restrictions can be defined by the project owner and participant organizations throughout the project's lifecycle. This enables every PM infrastructure to be configured to meet the requirements of every organization involved in its infrastructure.

These PKI data management components may offer the following features:

Real Time Adaptive Order Prioritization: as shown in the above equation, the priority of an order can be determined in real time to dynamically prioritize orders in a fluctuating system based on several factors.

Order Attribute and System State Driven Load Balancing: the load balancing of this system is driven by the types of orders and several other order attributes and the current state of the system, such as the number of orders and current occupancy of the order processors.

Business and Security Policy Driven Order Processing Procedure: the states all orders go through are driven by several business rules and security policies defined throughout the system by project owner and participant organizations. This is advantageous compared to other systems that segregate the processing states from other policies defined in the system.

### User Management Component

Users of the PKI management system from each organization are associated with one or more accounts and undergo both authentication and authorization. Users may belong to only one organization but can be associated with any of his or her organization's project accounts. Through an account association, a user can have access to a selected product or products for that project with which the user's organization is associated. For every project account a user is associated with, a set of one or more roles can be defined. Certain roles may be limited to specific account types. For example, the Policy Authority role can only be assigned to users associated with an owner account. Each role grants specific capabilities to a user in the scope of the account. In this way the infrastructure can create and manage a variety of users with different capabilities.

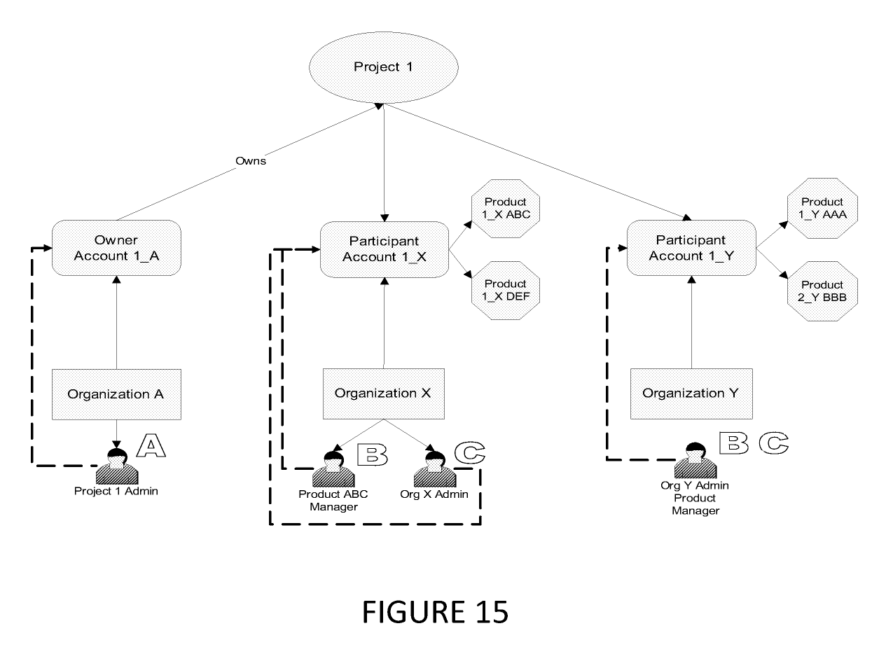

In FIG. 15 the different user roles are represented by different letters (i.e., A, B and C) at the top-right of the user icon. A user may have multiple roles assigned to each account association, each of which gives them a different level of access to the system. For instance, an administrator role assigned to an account may give the user the ability to manage other users associated with the account's products. However, this user may not manage the ID address allocations associated with the products. Conversely, that same administrator role assigned to a product may give that user the ability to manage the ID addresses associated with the product but not the users associated with the account the project is in.

Several different examples are shown in FIG. 15. For instance, the user Project 1 Admin is a member of the organization A, which serves as the owner organization. The user Project 1 Admin has Role A. The user Product ABC Manager is a member of Organization X and can access Product 1_X ABC with the abilities described by Role B. The user Org X Admin is a member of Organization X and has the abilities of Role C in order to manage the organization's account with Project 1. The user Org Y Project Manager is a member of Organization Y and manages the organization's account with Project 1 with Role C as well as managing products 1_Y AAA and 2_Y BBB with Role B.

For a more concrete example, as shown previously in FIG. 4, User Y_1 is a product administrator in project 1, but has no access to project 2. Similarly, User Y_2 is an account administrator in project 1 and is an authorized representative in project 2. User Y_2 does not have access to account administrator capabilities when working within project 2's domain.

Once authenticated, a user has access to every project his or her account is associated with in the system. Users may easily switch between project domains without needing to re-authenticate with the system. When switching project domains, the user is restricted to the set of roles granted in the selected project.

As stated in the sections above, users belonging to organizations outside of the service provider can be granted advanced configuration capabilities. Project owner users may configure the root certificate authority for their project and may set project wide policies governing the lifecycle and structure of participating organization's PKI data. Project participant users may create new products and select from various CA chains in real time.

User authentication may be performed using a trusted certificate chain. In particular, users may be provided with a security token device (e.g., a USB token) that stores a private/public key pair and a certificate signed by an authorized certificate authority. When the user accesses the PKI management system (e.g., by accessing its website through a web portal), the token provides the public certificate object to the system. When the user logs into the system, the token's private key and certificate are used for authentication and to provide secure access to the system. The certificate's validity is verified, for example, by ensuring it is signed by the authorized certificate authority and that the certificate's binary value matches the expected value stored in the system. If a certificate becomes inaccessible (which may occur if the token is lost or locked, for example), it is disabled and will no longer authenticate the user. A new certificate and private key are generated to provide continuing access for the user. Of course, other authentication techniques may be used instead of, or in addition to, token-based authentication.

The processes of authentication and authorization can be distinct and separate from one another or they may be combined. If they remain separate, the user's authentication certificate is only used to identify the user. The authority of the user can be stored as part of the user's record within the system. The user's certificate does not provide any information about the user's authority and does not need to be replaced or updated in the event that the user's account associations or authorized roles change. On the other hand, if the authentication and authorization processes are combined, an authentication certificate is generated specifying the user's project account associations, with the user roles specified in data contained in the certificate. This latter approach may provide a stricter model of authorization and requires a new certificate to be generated if a user's account associations or authorized roles change.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter

1. A method of establishing a process for provisioning a digital certificate service delivered by a PKI system, comprising:
receiving a request for a digital certificate service;
receiving data specifying a project that includes at least one product to be provisioned with a digital certificate;
receiving data specifying an identification of an owner organization of the project and at least one participant organization participating in the project;
receiving from the owner organization attributes with which PKI data to be included in the digital certificates is to comply; and
based on the received data and attributes, establishing an account for each of the organizations associated with the project through which users associated with each of the organizations can respectively request digital certificates for the at least one product in accordance with the attributes received from the owner organization.

2. The method of claim 1 further comprising:
based on the attributes received from the owner, generating a root certificate profile template that establishes a digital certificate format for digital certificates issued by all certificate authorities associated with the project;
receiving from a first one of the participant organizations a second set of attributes with which the PKI data is to comply when included in digital certificates issued for a first product in the project with which the first participant organization is associated;
based on the second set of attributes received from the first participant organization, generating a first child certificate profile template that establishes a digital certificate format for digital certificates issued by a sub-certification authority associated with the first participant organization.

3. The method of claim 1 wherein the attributes received from the owner organization include a minimum key size and certificate validity period.

4. The method of claim 2 wherein the second set of attributes include a PKI data format, an ID type used to identify a product, and a series of actions needed to generate the PKI data.

5. The method of claim 1 wherein the project includes at least a second product in which a second participant organization participates and further comprising:
receiving from the second participant organization a third set of attributes with which the PKI data is to comply when included in digital certificates issued for a second product in the project with which the second participant organization is associated;
based on the third set of attributes received from the second participant organization, generating a second child certificate template that establishes a digital certificate format for digital certificates issued by a sub-certification authority associated with the second participant organization.

6. The method of claim 5 further comprising establishing a first workflow defining actions needed to generate digital certificates for the first product and second workflow different from the first workflow which defines actions needed to generate digital certificates for the second product.

7. The method of claim 1 wherein a first of the accounts is established for a first of the participant organizations and further comprising:
receiving from a managing user in the first participant organization a specification of at least second and third users in the first participant organization who are to be authorized users of the system, wherein the second user is assigned a first role having a first level of access to the account of the first participant organization and the third user is assigned a second role having a second level of access to the account of the first participant organization that is different from the first level of access.

8. A system to enable a plurality of organizations participating in at least one project to provision customized digital certificate services for the project, comprising:
an account management component for establishing an account for each of the organizations associated with the project through which users associated with each of the organizations can respectively request digital certificates for at least one product included in the project;
a user management component configured to authenticate and authorize users associated with an owner organization of the project and at least one participant organization participating in the project who has been specified as a participant organization by the owner organization;
a certificate authority (CA) management component configured to generate at least one user-definable certificate profile template (CPT) that establishes a digital certificate format for digital certificates issued by all certificate authorities associated with the project;
a product management component configured to (i) establish attributes defined by the owner organization with which PM data to be included in the digital certificates is to comply and (ii) establish a workflow of activities to be performed in order to generate the digital certificates with the attributes that have been established; and
a PM management component configured to process user requests for digital certificates from users associated with the owner organization or at least one of the participant organizations in conformance with the user management component, certificate authority management component and the product management component.

9. The system of claim 8 wherein the certificate management component is further configured to generate a plurality of user-definable certificate profile templates each of which is associated with a certificate authority in a chain of certificate authorities associated with the participant organization such that a child certificate authority has a child certificate profile template that conforms to a parent certificate profile template.

10. The system of claim 8 wherein the product management component includes an ID management component configured to allocate IDs to products associated with the project in conformance with rules established by the project owner.

11. The system of claim 8 wherein the PKI management component is further configured to manage and maintain the PKI data for its entire lifecycle in conformance with participant organization preferences.

12. The system of claim 8 wherein the PKI management component includes an order processing management component for prioritizing user requests and, based on characteristics of each individual request, causes each request to be fulfilled in a serial manner with other requests or in a parallel manner in which different threads of a request are processed simultaneously with one another.

13. The system of claim 8 wherein the account management component is accessible to users over a communications network through a web-based user interface.

14. A method for provisioning products with digital certificates, comprising;
receiving a first request for a first series of digital certificates to be provisioned in products in a first product associated with a first PKI project;
authenticating and authorizing a first user submitting the request;
identifying a first organization associated with the first user and an owner organization of the first PKI project;
retrieving a root certificate profile template (CPT) associated with a root certificate authority of the owner organization and at least one additional CPT established by the first organization with which the first user is associated, wherein the root CPT specifies a format to which the first series of digital certificates are to conform and the at least one additional CPT further specifies the format to which the first series of digital certificates are to conform while remaining consistent with the root CPT format;
receiving from the first user a first set of PKI data that specifies values for predefined attributes to be included in the first series of digital certificates; and
generating the requested first series of digital certificates using the first set of PM data, wherein the first series of digital certificates are in conformance with the root CPT and the at least one additional CPT.

15. The method of claim 14 further comprising:
receiving a second request for a second series of digital certificates to be provisioned in products in a second product associated with the first PKI project;
authenticating and authorizing a second user submitting the request;
identifying a second organization associated with the second user;
retrieving at least one other CPT established by the second organization with which the second user is associated, wherein the at least one additional CPT further specifies a format to which the second series of digital certificates are to conform while remaining consistent with the root CPT format;
receiving from the second user a second set of PKI data that specifies values for predefined attributes to be included in the second series of digital certificates; and
generating the requested second series of digital certificates using the second set of PKI data, wherein the second series of digital certificates is in conformance with the root CPT and the at least one other CPT.

16. The method of claim 15 wherein generating the requested first and second series of digital certificates includes providing each of the first and second series of digital certificates with a product ID based on information included in the PKI data received from the first and second users, respectively.

17. The method of claim 14 wherein the first request is received by, and the digital certificates generated by, a PKI system and further wherein authenticating and authorizing the first user includes authorizing the first user to a first level of access to the PKI system specified by a managing user in first organization who has a higher level of privileges than the first user.

18. The method of claim 15 further comprising:
receiving a third request for a third series of digital certificates to be provisioned in products in a third product associated with a second PKI project in which the first organization participates;
authenticating and authorizing a third user submitting the request who is associated with the first organization;
identifying a second owner organization of the second PKI project;
retrieving a second root certificate profile template (CPT) associated with a second root certificate authority associated with the second owner organization and a chain of CPTs associated with a certificate chain established by the first organization, wherein the second root CPT specifies a format to which the third series of digital certificates are to conform and each CPT in the chain of CPTs further specifies the format to which the third series of digital certificates are to conform while remaining consistent with the second root CPT format;
receiving from the third user a third set of PKI data that specifies values for predefined attributes to be included in the third series of digital certificates;
generating the requested third series of digital certificates in conformance with the second root CPT and the chain of CPTs.

19. The method of claim 14 wherein the first organization is a corporate entity and the second organization is a consortium of corporate entities.

20. The method of claim 18 wherein each CPT in the chain of CPTs is used by a different sub-certificate authority associated with the first organization.
